(19) United States
(12) Patent Application Publication
(10) Pub. No.: US 2026/0036918 A1
(43) Pub. Date: Feb. 5, 2026

(54) POSITIVELY CHARGEABLE TONER AND TWO-COMPONENT DEVELOPER CONTAINING THE SAME

(71) Applicant: KYOCERA Document Solutions Inc., Osaka (JP)

(72) Inventor: Masashi YAMASHITA, Osaka (JP)

(73) Assignee: KYOCERA Document Solutions Inc., Osaka (JP)

(21) Appl. No.: 19/271,446

(22) Filed: Jul. 16, 2025

(30) Foreign Application Priority Data
Aug. 5, 2024 (JP) 2024-128662

(51) Int. Cl. G03G 9/093; G03G 9/113

(52) U.S. Cl. CPC G03G 9/09321; G03G 9/09342; G03G 9/09371; G03G 9/1136

(57) ABSTRACT

Positively chargeable toner has toner particles including a toner base particle and an external additive attached to its surface. The external additive includes first and second resin fine particles of silicone modified acrylic resin and a cleaning auxiliary particle. The first resin fine particle has a number average primary particle size of 30 nm or more but 50 nm or less, and the ratio of its coverage of the surface region of the toner base particle is 10% or more but 20% or less. The second resin fine particle has a number average primary particle size of 80 nm or more but 120 nm or less, and the ratio of its coverage of the surface region of the toner base particle is 10% or more but 20% or less. The cleaning auxiliary particle has a number average primary particle size of 100 nm or more but 300 nm or less.

### INCORPORATION BY REFERENCE

This application is based on and claims the benefit of priority from Japanese Patent Application No. 2024-128662 filed on Aug. 5, 2024, the contents of which are hereby incorporated by reference.

### BACKGROUND

The present disclosure relates to positively chargeable toner and two-component developer containing the same.

Generally, in an electrophotographic method, the surface of an electrostatic latent image carrying member is electrostatically charged by corona discharge or the like and then it is exposed to laser light or the like to form an electrostatic latent image; the formed electrostatic latent image is developed with toner to form a toner image; the formed toner image is transferred to a recording medium to produce a high-quality image. Typically, as toner for use in such an electrophotographic method, a binder resin such as a thermoplastic resin is blended with a colorant, a charge control agent, a release agent, a magnetic material, and the like and the mixture is subjected to kneading, pulverization, and classification to obtain toner particles (toner base particle) with an average particle size of 5 μm or more but 10 μm or less. Then, for the purpose of making the toner flowable, giving it satisfactory charging properties, and improving the cleaning properties of the toner against a photosensitive drum, an inorganic fine powder such as silica or titanium oxide is externally added to the toner base particle.

Mechanical stress of being stirred in a developer container causes changes, such as sinking-in or coming-off, in an external additive on the surface of toner. One known method, for the purpose of reducing such changes as sinking-in and coming-off in the external additive, is to use an external additive with a large diameter as a spacer particle. While silica can be used as spacer particles, when it is used in positively chargeable toner, to positively charge the toner, the silica particles themselves need to be subjected to a positive charging process, which process causes charging-induced faults (such as fogging). One method devised to cope with this is to use resin fine particles with a large particle size as spacer particles.

### SUMMARY

According to one aspect of the present disclosure, positively chargeable toner is composed of toner particles including a toner base particle and an external additive attached to the surface of the toner base particle. The external additive includes a first and a second resin fine particle formed of silicone modified acrylic resin and a cleaning auxiliary particle composed of an inorganic fine particle. The first resin fine particle has a number average primary particle size of 30 nm or more but 50 nm or less, and the ratio of coverage of the surface region of the toner base particle with the first resin fine particles is 10% or more but 20% or less. The second resin fine particle has a number average primary particle size of 80 nm or more but 120 nm or less, and the ratio of coverage of the surface region of the toner base particle with the second resin fine particles is 10% or more but 20% or less. The cleaning auxiliary particle has a number average primary particle size of 100 nm or more but 300 nm or less.

### BRIEF DESCRIPTION OF THE DRAWINGS

FIG. 1 is a diagram showing one example of the sectional structure of positively chargeable toner according to the present disclosure.

FIG. 2 is a diagram schematically showing how an external additive moves at an edge part of a cleaning blade during the cleaning of the surface of a photosensitive drum with the cleaning blade, showing a conventional example in which only second resin fine particles with a larger particle size are added as the external additive.

FIG. 3 is a diagram schematically showing how an external additive moves at the edge part of the cleaning blade during the cleaning of the surface of the photosensitive drum with the cleaning blade, showing a configuration of the present disclosure where first and second resin fine particles and cleaning auxiliary particles are added as the external additives.

### DETAILED DESCRIPTION

Now, an embodiment of the present disclosure will be described in detail. Unless otherwise defined, a result of evaluation with respect to a powdery substance (specifically, toner core particle, toner base particle, external additive, toner, and the like) is given as a number average of values obtained by measuring respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (LA-750; manufactured by HORIBA, Ltd.). Unless otherwise defined, measured values of an acid number and a hydroxyl number are values obtained by measuring in accordance with “JIS (Japanese Industrial Standards) K0070-1992.” Unless otherwise defined, measured values of a number average molecular weight (Mn) and a mass average molecular weight (Mw) are values measured using gel permeation chromatography.

In the following description, “-based” is occasionally appended to the name of a compound to collectively refer to that substance and their derivatives. Whenever the name of a compound has “-based” appended to it to refer to the name of a polymer, the repeating unit in that polymer is derived from any of that compound and their derivatives. The term “(meth)acryl” is occasionally used to refer to “acrylic” and “methacrylic” collectively. The term “(meth)acryloyl” is occasionally used to refer to “acryloyl (CH₂═CH—CO—)” and “methacryloyl (CH₂═C(CH₃)—CO—)” collectively.

Toner according to the embodiment can be suitably used, for example, as positively chargeable toner for development of electrostatic latent images. The toner according to the embodiment is a powdery substance containing a plurality of toner particles (particles each configured as described later). The toner can be used as one-component developer. Or, the toner can be mixed with carrier using a mixer (e.g., ball mill) to prepare two-component developer. To form a high-quality image, it is preferable to use ferrite carrier as the carrier.

To form a high-quality image over a long period, it is preferable to use magnetic carrier particles that have a carrier core and a resin layer coating the carrier core. To produce magnetic carrier particles, the carrier core can be formed with a magnetic material (e.g., ferrite), or the carrier core can be formed with a resin having magnetic particles dispersed in it. Or, magnetic particles can be dispersed in the resin layer coating the carrier core. To form a high-quality image, the amount of toner in two-component developer is preferably 5 parts by mass or more but 15 parts by mass or less for 100 parts by mass of carrier. Positively chargeable toner is positively charged by friction with carrier.

A toner particle in the toner according to the embodiment has a toner base particle and an external additive attached to the surface of the toner base particle. That is, a toner particle before the external additive attaches to it is referred to as “toner base particle.” In addition, if the toner base particle has a shell layer, a particle before the shell layer is formed is referred to as “toner core particle.” If a toner base particle has no shell layer, the toner base particle is also referred to as “toner core particle.”

The toner according to the embodiment can be used to form an image, for example, on an electrophotographic apparatus (image forming apparatus). One example of an image forming method on an electrophotographic apparatus will be described below.

First, based on image data, an electrostatic latent image is formed on a photosensitive member (e.g., a superficial part of a photosensitive drum). Next, the formed electrostatic latent image is developed with developer containing toner. In the development process, toner (e.g., toner electrostatically charged by friction with carrier or a blade) on a development sleeve (e.g., a superficial part of a development roller in the developing device) disposed near the photosensitive member is attached to the electrostatic latent image to form a toner image on the photosensitive member. In the subsequent transfer process, the toner image on the photosensitive member is directly transferred to a recording medium (e.g., sheet); or it is primarily transferred to an intermediate transfer member (e.g., a transfer belt) and then the toner image on the intermediate transfer member is secondarily transferred to the recording medium. Then, the toner is heated to fix the toner to the recording medium. As a result, an image is formed on the recording medium. By superposing on each other toner images of four colors, for example, black, yellow, magenta, and cyan, it is possible to form a full-color image.

### [1. Basic Configuration of Toner]

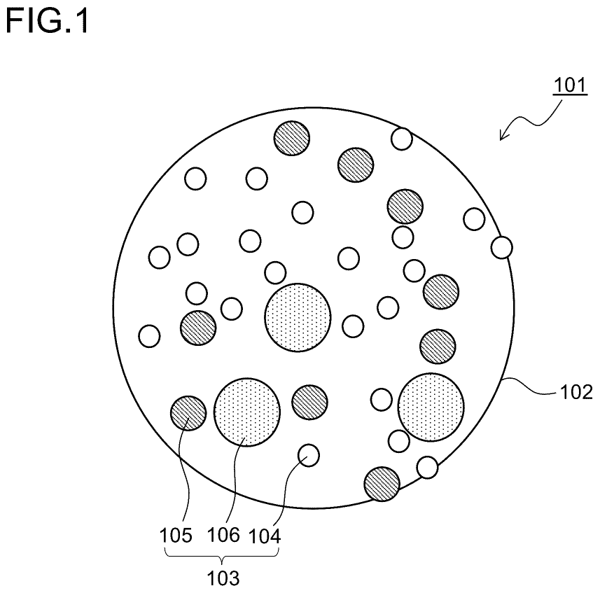

FIG. 1 is a diagram showing one example of the sectional structure of positively chargeable toner 101 according to the present disclosure. As shown in FIG. 1, the positively chargeable toner (hereinafter, referred to simply as toner) 101 according to the present disclosure has a toner base particle 102 and an external additive 103 attached to the surface of the toner base particle 102. The external additive 103 contains first resin fine particles 104, second resin fine particles 105, and cleaning auxiliary particles 106.

The first resin fine particle 104 has a number average primary particle size of 30 nm or more but 50 nm or less. The ratio of coverage of the surface of the toner base particle 102 with first resin fine particles 104 (the proportion in area of the region covered with first resin fine particles 104 out of the surface region of the toner base particle 102) is 10 to 20%. The first resin fine particle 104 is formed of silicone modified acrylic resin.

The second resin fine particle 105 has a larger particle size than the first resin fine particle 104. The second resin fine particle 105 has a number average primary particle size of 80 nm or more but 120 nm or less. The ratio of coverage of the surface of the toner base particle 102 with second resin fine particles 105 (the proportion in area of the region covered with second resin fine particles 105 out of the surface region of the toner base particle 102) is 5 to 12%. The second resin fine particle 105 is formed of silicone modified acrylic resin.

The cleaning auxiliary particle 106 has a larger particle size than the second resin fine particle 105. The cleaning auxiliary particle 106 has a number average primary particle size of 100 nm or more but 300 nm or less. The cleaning auxiliary particle 106 is an inorganic fine particle (e.g., strontium titanate particle).

Giving the first and second resin fine particles 104 and 105 particle sizes and coverage ratios in the ranges described above allows the first and second resin fine particles 104 and 105 to properly function as spacer particles, achieving a satisfactory charging stability. It also reduces the dropping-off of the first and second resin fine particles 104 and 105 from the surface of the toner base particle 102. Thus, it is possible to suppress, in cleaning the photosensitive drum with a cleaning blade, the slipping-through of the external additives at an edge part of the cleaning blade.

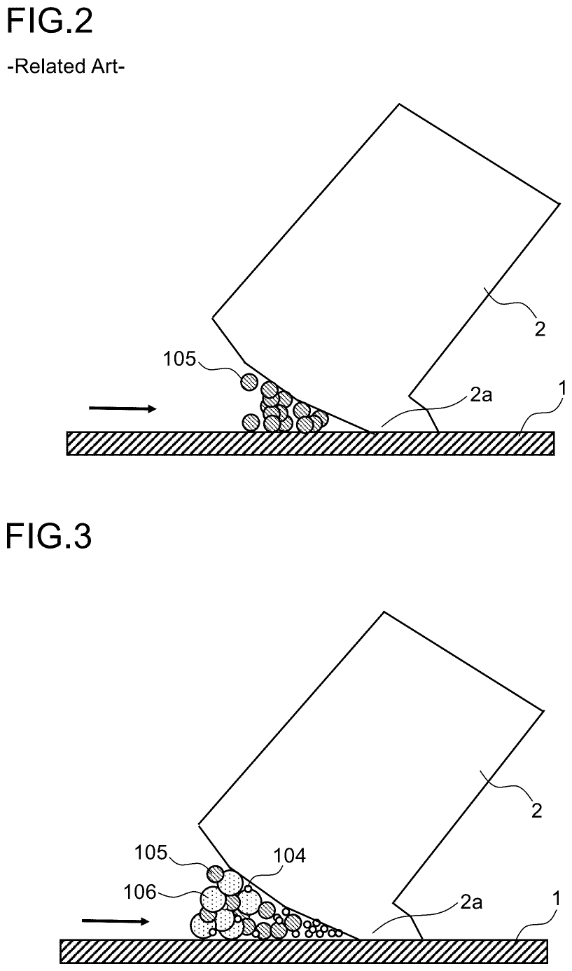

FIGS. 2 and 3 are diagrams schematically showing how the external additive moves at an edge part 2a of the cleaning blade 2 during the cleaning of the surface of the photosensitive drum 1 with the cleaning blade 2. FIG. 2 shows a conventional example in which only the second resin fine particle 105 with a larger particle size is added as an external additive and FIG. 3 shows the configuration of the present disclosure where the first and second resin fine particles 104 and 105 and the cleaning auxiliary particle 106 are added as external additives. The arrow in the diagrams indicate the movement direction of the surface of the photosensitive drum 1.

When only the second resin fine particle 105 with a larger particle size is added as an external additive, as shown in FIG. 2, second resin fine particles 105 form an agglomeration. The formed agglomeration then slips under the edge part 2a of the cleaning blade 2 (into a nip portion between the photosensitive drum 1 and the cleaning blade 2) under the conveyance force from the photosensitive drum 1 and pushes up the cleaning blade 2. Thus, at the edge part 2a, the slipping-through of the external additives occurs.

When the first and second resin fine particles 104 and 105 and the cleaning auxiliary particle 106 are added as the external additive, as shown in FIG. 3, a layer of first resin fine particles 104 with a smaller particle size is present at the edge part 2a. This keeps second resin fine particles 105 away from the edge part 2a. This helps suppress the pushing up of the cleaning blade 2 by the agglomeration of second resin fine particles 105.

In addition, forming the first and second resin fine particles 104 and 105 of silicone modified acrylic resin reduces, with silicone in those particles, the attachment force of the first and second resin fine particles 104 and 105. This helps suppress the formation of the agglomeration of first and second resin fine particles 104 and 105. Thus, it is possible to effectively suppress the slipping-through of the external additives at the edge part 2a.

Owing to the cleaning auxiliary particle 106, the external additive layer has increased flowability at the edge part 2a, suppressing the formation of the agglomeration of second resin fine particles 105. This helps efficiently scrape off the second resin fine particles 105 with the cleaning blade 2. Thus, it is possible to suppress the movement of second resin fine particles 105 with the larger particle size to the edge part 2a, more effectively suppressing the slipping-through of the external additives.

### [2. Materials for Toner]

Next, components that are essential or optional for the toner according to the present disclosure will be described. The toner core particle at least includes a binder resin. The toner core particle can also include, in the binder resin, a release agent, a colorant, a charge control agent, a magnetic powder, and the like as needed.

A description will be given below, one by one, of the binder resin, the release agent, the charge control agent, the colorant, and the magnetic powder that form the toner core particle, the resin fine particles that form a shell layer, the first and second resin fine particles and the cleaning auxiliary particle that constitute the external additive, and a method of producing the toner according to the present disclosure.

### (Binder Resin)

In the toner according to the present disclosure, the toner core particle contains a binder resin. The binder resin that can be contained in the toner particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties on sheets, those containing at least one of polyester resin and styrene-acrylic acid-based resin is preferred, and polyester resin is more preferred. The polyester resin will be described below.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components or carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentantriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azclaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalenc tricarboxylic acid, 1,2,4-butanetricarboxylic acid, 1,2,5-hexantricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components may be used as ester-forming derivatives such as acids halide, acids anhydride, and lower alkyl esters. Here, the term “lower alkyl” denotes an alkyl group with one to six carbon atoms.

When the binder resin is a polyester resin, the softening point of the polyester resin is preferably 70° C. or more but 130° C. or less, and more preferably 80° C. or more but 120° C. or less. For improved mechanical strength of the toner core particle and improved fixing properties of the toner, the number average molecular weight (Mn) of the polyester resin is preferably 1000 or more but 2000 or less. The molecular weight distribution of the polyester resin (the ratio Mw/Mn of mass average molecular weight (Mw) to number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly have a cross-linked structure helps improve the heat-resistant preservation properties and durability of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tends to be poor. If the glass transition point is too low, the heat-resistant preservation properties of the toner tends to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter (DSC-6200; manufactured by Seiko Instruments Inc.) as a measuring instrument. 10 mg of a measurement sample is put in an aluminum pan while an empty aluminum pan is used as a reference. From the endothermic curve plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Release Agent)

For the purpose of improving its fixing properties and offset resistance, the toner core particle can contain a release agent. The type of release agent that can be contained in the toner core particle is not particularly limited within the scope consistent with the object of the present disclosure. As the release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding these release agents to the toner core particle 102 helps more efficiently suppress offsetting and image smearing (stain around an image caused by its being rubbed).

When a polyester resin is used as the binder resin, from the viewpoint of compatibility, as a release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as a release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by the DSC measurement falls within the range of 100° C. or more but 120° C. or less. Examples of such types of Fischer-Tropsch wax include the following products available from Sasol Ltd.: Sasol Wax Cl (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner core particle 102, preferably 1 mass % or more but 10 mass % or less. Too small an amount of release agent used can result in less-than-expected suppression of offsetting or image smearing in image formation; too large an amount of release agent used can result in fusing-together of toner and hence poor heat-resistant preservation properties of toner.

### (Colorant)

The toner core particle can contain a colorant. As the colorant that can be contained in the toner core particle, any known pigment or dye that suits the color of the toner can be used. Specific examples of colorants that can be suitably added to the toner include: black pigments such as carbon black, acetylene black, lamp black, aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, permanent Red 4R, lithol red, pyrazolone red, Watchung red calcium salt, lake red D, brilliant carmine 6B, cosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated victoria blue, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as barite powder, barium carbonate, clay, silica, white carbon, talc, and alumina white. Two or more of these colorants can be used in combination for the purpose of adjusting the toner to the desired hue and the like.

The amount of colorant used is not particularly limited within the scope consistent with the object of present disclosure. Specifically, the amount of colorant used is, relative to the total mass of the toner core particle, preferably 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

The toner core particle can contain a charge control agent for the purposes of improving the charge level of the toner and the charge response properties as the index of whether it can be charged to a predetermined charge level in a short time, and thereby obtaining toner with excellent durability and stability. Since the toner according to the present disclosure is a positively chargeable toner used in development with it positively charged, a positively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxiazine, orthothiazine, metathiazine, parathiazinc, 1,2,3-triazine, 1,2,4-triazine, 1,3,5-triazine, 1,2,4-oxadiazine, 1,3,4-oxadiazinc, 1,2,6-oxadiazine, 1,3,4-thiadiazine, 1,3,5-thiadiazine, 1,2,3,4-tetrazine, 1,2,4,5-tetrazinc, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azinc deep black EW, and azine deep black 3RL; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. More specific examples include: styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins are not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include esters of alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminocthyl (meth)acrylate, diethyl aminocthyl (meth)acrylate, dipropyl aminocthyl (meth)acrylate, and dibutyl aminocthyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is, relative to the total mass of the toner core particle, preferably 0.1 mass % or more but 10 mass % or less. Too small an amount of charge control agent makes it difficult to stably charge the toner with a predetermined polarity. This can lead to a lower-than-expected value in the image density of the formed image and make it difficult to maintain satisfactory image density for a long period. Also, the charge control agent is then difficult to disperse evenly, and this tends to cause fogging in the formed image and contamination of a latent image carrying member with toner components. Too large an amount of charge control agent can lead to poorer resistance to environment and this tends to cause image faults in the formed image due to insufficient charging under high temperature and high humidity, contamination of a latent image carrying member with toner components, and the like.

### (Magnetic Powder)

The toner core particle can contain a magnetic powder. Suitably usable as a material of the magnetic powder is, for example, a ferromagnetic metal (more specifically, iron, cobalt, nickel, an alloy of one or more of these metals, or the like), a ferromagnetic metal oxide (more specifically, ferrite, magnetite, chromium dioxide, or the like), or a material subjected to a ferromagnetization treatment (more specifically, a carbon material to which ferromagnetic properties are given by heat treatment, or the like). For the purpose of suppressing the elution of a metal ion (e.g., iron ion) from the magnetic powder, preferably, a surface-treated magnetic particles are used as the magnetic powder. One type of magnetic powder can be used singly or a plurality of types of magnetic powder can be used in combination.

The toner core particle can have, if so desired, its surface coated by a shell layer. If the toner core particle has a shell layer formed on it, the shell layer is formed of resin fine particles. To give the shell layer an adequate level of surface absorption, it is particularly preferable that the shell layer include a resin film composed mainly of an agglomeration of resin particles with a glass transition point of 50° C. or more but 100° C. or less; that heat-resistant particles forming the resin film have a number average circularity of 0.55 or more but 0.75 or less; that the heat-resistant particles contain a resin having one or more types of repeating unit derived from a styrene-based monomer, a repeating unit having an alcoholic hydroxyl group, and a repeating unit derived from a nitrogen-containing vinyl compound; and that the repeating unit with the highest mass proportion among the repeating units in the resin contained in the heat-resistant particle is a repeating unit derived from a styrene-based monomer.

With regard to the shell layer described above (i.e., the resin film composed mainly of an agglomeration of heat-resistant particles), to give the toner satisfactory heat-resistant preservation properties, fixing properties, and charging properties, preferably, the shell layer has a thickness of 10 nm or more but 35 nm or less. The thickness of the shell layer can be measured, by using a commercially available image analysis software (e.g., “WinROOF;” developed by MITANI CORPORATION), analyzing a TEM (transmission electron microscopy) image of a section of the toner particle. If, in one toner particle, the shell layer has an uneven thickness, this can be coped with by measuring the thickness of the shell layer at four points evenly apart from each other (specifically, four points at which two straight lines drawn to orthogonally intersect substantially at the center of a section of the toner particle cross the shell layer) and taking the arithmetic average of the obtained four measurement values as the evaluation value (the thickness of the shell layer) of that toner particle. The boundary between the toner core particle and the shell layer can be recognized, for example, by selectively staining only the shell layer of the toner core particle and the shell layer. If, in the TEM image, the boundary between the toner core particle and the shell layer is obscure, TEM and electron energy loss spectroscopy (EELS) can be used in combination to map elements characteristic of the shell layer. This clarifies the boundary between the toner core particle and the shell layer.

With regard to the shell layer described above (i.e., the resin film composed mainly of an agglomeration of heat-resistant particles), to give the toner satisfactory heat-resistant preservation properties, fixing properties, and charging properties, preferably, the shell layer covers 50% or more but 80% or less of the area of the surface region of the toner core particle. The proportion in area of the region covered by the shell layer out of the surface region of the toner core particle can be determined by obtaining an image of the surface of the toner particle (e.g., a previously stained toner particle) using an electron microscope and analyzing the obtained image using commercially available image analysis software.

### (External Additive)

In the toner according to the present disclosure, the surface of the toner core particle (the surface of the shell layer if the shell layer is formed on the surface of the toner core particle) is treated with an external additive. In the following description, the toner core particle before being treated with the external additive is referred to also as toner base particle. The toner according to the present disclosure includes as the external additive the first resin fine particles, the second resin fine particles, and the cleaning auxiliary particles.

### (First Resin Fine Particle)

The first resin fine particle is formed of silicone modified acrylic resin with a silicone part and an acrylic part. The silicone modified acrylic resin is constituted by acryl as a main chain backbone bonded to silicone as a side chain, so that it is a resin with separation properties and lubricating properties characteristic of silicone. Silicone modified acrylic resin is obtained by copolymerizing a polydiorganosiloxane macromer having an acrylic-based functional group and a radical polymerizable organic monomer.

A monomer as mentioned above can be co-polymerizable with another monomer. Examples of other co-polymerizable monomers include: styrene-based monomers such as styrene, methylstyrene, methoxystyrene, ethylstyrene, propylstyrene, butylstyrene, phenylstyrene, and chlorostyrene; and ester actylate-based or ester methactylate-based monomers such as methyl acrylate, ethyl acrylate, propyl acrylate, butyl acrylate, pentyl acrylate, dodecyl acrylate, stearyl acrylate, ethylhexyl acrylate, lauryl acrylate, methyl methacrylate, ethyl methacrylate, propyl methacrylate, butyl methacrylate, pentyl methacrylate, dodecyl methacrylate, stearyl methacrylate, ethylhexyl methacrylate, and lauryl methacrylate.

The first resin fine particle has a number average primary particle size of 30 nm or more but 50 nm or less. The ratio of coverage of the surface of the toner base particle with first resin fine particles is 10 to 20%.

### (Second Resin Fine Particle)

The second resin fine particle is formed of silicone modified acrylic resin like the first resin fine particle. The second resin fine particle has a number average primary particle size of 80 nm or more but 120 nm or less. The ratio of coverage of the surface of the toner base particle with second resin fine particles is 5 to 12%.

### (Cleaning Auxiliary Particle)

The cleaning auxiliary particle is formed of an inorganic material. Examples of inorganic materials include silica, alumina, titanium oxide, magnesium oxide, zinc oxide, strontium titanate, and barium titanate. The cleaning auxiliary particle has a number average primary particle size of 100 nm or more but 300 nm or less. The amount of cleaning auxiliary particles added is 0.5 to 2.0 parts by mass for 100 parts by mass of the toner core particle.

In addition to the first resin fine particle, the second resin fine particle, and the cleaning auxiliary particle described above, any other external additive can be added within the scope consistent with the object of the present disclosure. The type of external additive that can be added is not particularly limited and thus any external additive known to be used in toner can be appropriately selected. Two or more types of such external additives can be used in combination.

In a case where the toner according to the present disclosure is blended with carrier to be used as two-component developer, using as the carrier silicone-coated carrier coated with silicone resin helps suppress carrier contamination due to the attachment of the external additive to the carrier. This is possible because the silicone resin in the coat layer has low adhesion and because the first and second resin fine particles (spacer particles) in the toner, owing to its being formed of silicone modified acrylic resin, can be restrained from attaching to the carrier. Moreover, since the coat layer of the carrier and the spacer particles are both formed of silicone-based material, even if the spacer particles attach to the carrier, it is possible to suppress the change of the charge amount of the carrier.

### [Production Method for Toner]

Next, a production method for the toner according to the present disclosure will be described. The production method for the toner includes a production method for the toner core particle and a method for external addition treatment to attach the external additives to the surface of the toner base particle. The production method for the toner core particle is not particularly limited so long as it can form the toner core particle with a predetermined structure. As necessary, a toner core particle coated with a shell layer can be used as the toner base particle. As a suitable production method for the positively chargeable toner described above, a method for producing the toner core particle, a method for forming the shell layer, and the method for external addition treatment will be described one by one below.

### (Method for Producing the Toner Core Particle)

The method for producing the toner core particle is not particularly limited so long as it can satisfactorily disperse any optional components such as a colorant, a release agent, a charge control agent, and a magnetic powder in the binder resin. Examples of suitable methods for producing the toner core particle include a pulverization method and an agglomeration method.

In the pulverization method, the binder resin and any components such as a colorant, a release agent, a charge control agent, and a magnetic powder are mixed using a mixer and the like; then the binder resin and the components blended in the binder resin are melted and kneaded using a kneader such as a uniaxial or biaxial extruder; and the cooled kneaded product is pulverized and classified. While the average particle size of the toner core particle is not particularly limited within the scope consistent with the object of the present disclosure, generally it is preferably 5 μm or more but 10 μm or less.

In the agglomeration method, in an aqueous medium containing fine particles of each of the binder resin, a release agent, a charge control agent, and a colorant, these fine particles are agglomerated until they have a predetermined particle size. This forms an agglomerate particle containing the binder resin, the release agent, the charge control agent, and the colorant. Subsequently, the obtained agglomerate particle is heated so that the components in the agglomerate particle coalesce. This yields a toner core particle with a predetermined particle size.

### (Method for Forming Shell Layer)

To coat the surface of the toner core particle with the shell layer, resin fine particles are attached to the surface of the toner core particle to form the shell layer.

The method will be described more specifically. First, in a mixing apparatus, hydrochloric acid is added to ion-exchange water to prepare an aqueous medium with weak acidity (e.g., with a pH value selected from the range of three or more but five or less). Subsequently, to the aqueous medium with the so adjusted pH value, a dispersion liquid (suspension) of resin fine particles as a shell material and the toner core particle are added.

Subsequently, while the mixture liquid containing the shell material and the toner core particle is stirred, the temperature of the mixture liquid is raised up to a predetermined holding temperature (e.g., a temperature selected from the range of 50° C. or more but 90° C. or less) at a predetermined rate (e.g., a rate selected from the range of 0.1° C./min or more but 3° C./min or less). Then, the mixture liquid is, while being stirred, held at the predetermined holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of toner base particles.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that the particles of the external additive do not sink in the toner base particle.

The toner according to the present disclosure described above excels in fixing properties and heat-resistant preservation properties. In cases where images are formed for a long period in various environments including a high-temperature high-humidity environment and low-temperature low-humidity environment, the toner can be electrostatically charged to a desired charge amount. Thus, the images can be formed with the desired density. Accordingly, the toner according to the present disclosure can be suitably used in a variety of image forming apparatuses. Now, the effects of the present disclosure will be described more specifically by way of examples. The present disclosure is not limited in any way by those examples.

### EXAMPLES

### Production Example 1

### (Production of Polyester Resin)

Non-crystalline polyester resin for use as the binder resin of the toner core particle was synthesized in the following method. A reaction vessel equipped with a thermometer (thermocouple), a dehydration tube, a nitrogen introduction tube, and a stirrer (stirring blades) was set in an oil bath. 1575 g of BPA-PO (bisphenol A propylene oxide adduct), 163 g of BPA-EO (bisphenol A ethylene oxide adduct), 377 g of fumaric acid, and 4 g of a catalyst (dibutyltin oxide) were put into the reaction vessel. After nitrogen substitution inside the reaction vessel, while the contents were being stirred, the temperature in the reaction vessel was raised to 220° C. Then, in a nitrogen atmosphere, under the condition of a temperature of 220° C., while byproduct water was distilled away, the contents in the reaction vessel were polymerized for eight hours. The pressure in the reaction vessel was decreased and then the contents in the reaction solution was polymerized for another one hour in a reduced-pressure atmosphere (a pressure of 60 mmHg), under the condition of a temperature of 220° C. Subsequently, the temperature in the reaction vessel was lowered to 210° C. and then 336 g of trimellitic acid anhydride was added into the reaction vessel. Then the contents in the reaction vessel were reacted under the conditions of a reduced-pressure (a pressure of 60 mmHg) and a temperature of 210° C. After that, the reacted product was taken out of the reaction vessel and was then cooled to obtain non-crystalline polyester resin.

### Production Example 2

### (Production of Toner Base Particles)

The following were mixed using an FM mixer (FM-10B, manufactured by NIPPON COKE & ENGINEERING CO., LTD.) to obtain a mixture: as a binder resin, 100 mass parts of the non-crystalline polyester resin obtained in production example 1; as a colorant, 4 mass parts of copper phthalocyanine blue pigment (C.I. Pigment Blue 15:3); as a charge control agent, 1 mass part of quaternary ammonium salt (BONTRON (registered trademark) P-51, manufactured by ORIENT CHEMICAL INDUSTRIES CO., LTD); and as a release agent, 5 mass parts of carnauba wax (specially made carnauba wax No. 1, manufactured by S. KATO & CO.). Then, the mixture was melted and kneaded using a biaxial extruder (PCM-30, manufactured by IKEGAI CO., LTD.) to obtain a kneaded product. The melt-kneading was carried out under the conditions of a set temperature of 120° C., a rotation rate of 150 rpm, and a processing rate of 5 kg/hour. The kneaded product was pulverized using a mechanical pulverizer (Turbomill, manufactured by FREUND-TURBO CORPORATION) to obtain a pulverized product. The pulverized product was then classified using a classifier (Elbow Jet, manufactured by Nittetsu Mining Co., Ltd.) to obtain toner base particles (toner core particles) with a volume average particle size (D50) of 6.8 μm. The volume average particle size of the toner base particle was measured using a Coulter Counter Multisizer 3 (manufactured by Beckman Coulter, Inc.).

### Production Example 3

### (Production of Silicone Modified Acrylic Resin Fine Particles)

Sufficient substitution with nitrogen gas was carried out inside a reaction vessel equipped with a stirrer, a thermometer, a nitrogen introduction tube, a reflux tube, and a dropping funnel. The reaction vessel was loaded with 100 g of ion-exchange water, 10 g of sodium dodecylbenzenesulfonate, and 2.5 g of polyethylene glycol nonylphenyl ether, then 1 g of ammonium persulfate and 0.4 g of sodium hydrogen sulfite were added, and the temperature was raised to 60° C. Next, 35 g of butyl acrylate, 40 g of methyl methacrylate, 20 g of butyl methacrylate, 10 g of vinylsilane triolpotassium salt, and 5 g of 3-methacryloxy propylmethyl dimethoxy silane were dropped into the reaction vessel over a period of three hours. Meanwhile, polymerization was carried out such that the polymerization reaction solution was adjusted to have a pH value of 7 with an aqueous solution of ammonium. Particles after polymerization were dried to obtain silicone modified acrylic resin fine particles (RA1).

Silicone modified acrylic resin fine particles with different particle sizes (RA2 to RA5, RB1 to RB5) were also obtained by a procedure similar to the one described above except that the added amounts of sodium dodecylbenzenesulfonate and polyethylene glycol nonylphenyl ether were changed.

### Production Example 4

### (Production of Non-Silicone Modified Acrylic Resin Fine Particle)

Sufficient substitution with nitrogen gas was carried out inside a reaction vessel equipped with a stirrer, a thermometer, a nitrogen introduction tube, a reflux tube, and a dropping funnel. The reaction vessel was loaded with 100 g of ion-exchange water and 3.8 g of sodium lauryl sulfate, and the temperature in the reaction vessel was raised to 80° C. Next, while the contents were stirred at a rotation rate of 100 rpm, 0.5 g of ammonium persulfate was added and then the mixture of monomers (35 g of methyl methacrylate and 15 g of n-butyl acrylate) was dropped into the reaction vessel over a period of one hour. After that, the contents were stirred at a rotation rate of 100 rpm over a period of one hour. The obtained emulsion was dried to obtain non-silicone modified acrylic resin fine particles (RC1).

Non-silicone modified acrylic resin fine particle (RC2) with a different particle size was also obtained by a procedure similar to the one described above except that the added amount of sodium lauryl sulfate was changed to 1.5 g.

### Production Example 5

### (Production of Cleaning Auxiliary Particles)

To titanyl sulfate (manufactured by YONEYAMA YAKUHIN KOGYO CO., LTD.), a 4N aqueous solution of sodium hydroxide was added to prepare a solution with a pH value of 9.0 (de-sulfation treatment). To the solution, 6N hydrochloric acid was added to adjust the pH value to 5.5 and the result was filtered and washed with water. After washing, to the filtrate in the form of wet cake, water was added to prepare a slurry. The amount of water added was determined such that the TiO₂-equivalent concentration of the slurry was 1.25 mol/L. To the slurry, 6N hydrochloric acid was added to adjust a pH value to 1.2 (deflocculation treatment). Out of the slurry after deflocculation treatment, TiO₂-equivalent 0.156 mol of the slurry was put into a reaction vessel with a volume of 3 L. To the reaction vessel, an aqueous solution of strontium chloride was added. The reaction solution after the addition had a SrO/TiO₂-equivalent molar ratio of 1.15 and its TiO₂-equivalent concentration was 0.156 mol/L. After that, substitution with nitrogen gas was carried out inside the reaction vessel and, while the mixture solution in the reaction vessel was stirred and mixed under the condition of 300 rpm, the temperature was raised to 90° C. under the condition of 13.5° C./min. Then, the mixture solution was kept at 90° C. and, while it was stirred and mixed under the condition of 300 rpm, 143 mL of 2.5N aqueous solution of sodium hydroxide was added over a predetermined period (addition period T). Next, the mixture solution was stirred and reacted under the conditions of 90° C., one hour, and 600 rpm. After the reaction, the mixture solution was cooled to 40° C. and the supernatant in the mixture solution was removed under a nitrogen atmosphere.

Subsequently, under a nitrogen atmosphere, to a precipitate (product) in the mixture solution, 2.5 L of pure water was added and then an operation of decantation (washing operation) for removing the supernatant was performed twice. After the washing, the product was filtered using a Buchner funnel and the obtained filtrate (product) in the form of wet cake was dried under the atmosphere at 110° C. for eight hours. This yielded a particle base material (strontium titanate particle). The obtained particle base material and 24 g of isopropyl tri-isostearoyl titanate (PLENACT (registered trademark), manufactured by Ajinomoto Fine-Techno Co., Inc.) as a titanate coupling agent were put into a mixer (nanopersion piccolo, manufactured by KAWATA MFG. CO., LTD.) and were mixed under the conditions of 80° C., one hour, and 6000 rpm. Then, the obtained mixture was dried at 110° C. for twelve hours. After that, the dried mixture was pulverized using a pulverizer. This yielded cleaning auxiliary particles (CP1).

Cleaning auxiliary particles with different particle diameters (CP2 to CP5) were also obtained by a procedure similar to the one described above except that the addition period T for the 2.5N aqueous solution of sodium hydroxide was changed.

### Production Example 6

### (Production of Toner)

The following were mixed for five minutes using an FM mixer (FM-10B, manufactured by NIPPON COKE & ENGINEERING CO., LTD.) under the condition of 4,000 rpm: 100 mass parts of the toner base particle obtained in production example 2; 1.5 mass parts of silica particles; 0.48 mass parts of silicone modified acrylic resin fine particle RA1 (first resin fine particle) and 0.6 mass parts of silicone modified acrylic resin fine particle RB1 (second resin fine particle) each obtained in production example 3; and 1.2 mass parts of the cleaning auxiliary particle obtained in production example 5. Used as silica particles was AEROSIL REA90 (manufactured by NIPPON AEROSIL CO., LTD., dry silica that is surface-treated to be positively chargeable, with a number average primary particle size of 20 nm). The obtained mixture was sieved using a sieve with a mesh of 200 (a sieve opening of 75 μm) to obtain the toner of Practical Example 1 of the present disclosure.

The types and addition amount of the first and second resin fine particles (namely, RA1 to RA5, RB1 to RB5, RC1, and RC2) and of the cleaning auxiliary particle (namely, CP1 to CP5) were appropriately changed to obtain the toners of Practical examples 2 to 11 of the present disclosure and Comparative Examples 1 to 13.

### Production Example 7

### (Production of Silicone-Coated Carrier)

The following were mixed using a homo-mixer to obtain a coating liquid: 361.2 g of a silicone resin solution (KR-255, manufactured by Shin-Etsu Chemical Co., Ltd.; solid concentration: 50 mass %); 9.0 g of barium titanate (BT-01, manufactured by SAKAI CHEMICAL INDUSTRY CO., LTD.; primary particle size: 102 nm); 5.4 g of carbon black (KETJENBLACK EC-300J, Lion Specialty Chemicals Co., Ltd.); and 1444.8 g of toluene.

While, using a fluidized bed-coating machine (model FD-MP-01D, manufactured by Powrex Corporation), 5000 g of carrier core were kept flowing, a coating liquid was sprayed to the carrier cores. In this way, the carrier cores coated with the coating liquid were obtained. The coating was carried out under the conditions of an aeration temperature of 75° C., an aeration air flow rate of 0.3 m³/min, and a rotor rotation rate of 400 rpm. Used as the carrier cores were manganese ferrite cores (manufactured by DOWA IP CREATION CO., LTD.; median diameter: 20.3 μm, saturation magnetization: 67 emu/g). The carrier cores coated with the coating liquid were baked for one hour at 200° C. using an electric furnace to obtain silicone-coated carrier having a coat layer formed on the surface of a carrier core.

### Production Example 8

### (Production of Developer)

100 mass parts of the silicone-coated carrier obtained in production example 7, 8 mass parts of each of the toners of Practical Examples 1 to 11 and Comparative Examples 1 to 13 obtained in production example 6 were mixed for thirty minutes using a ball mill to prepare evaluation developer (two-component developer).

### [Measurement of Average Particle Size of Resin Fine Particle and Cleaning Auxiliary Particle]

The primary particle sizes of resin fine particles RA1 to RA5, RB1 to RB5, RC1 and RC2 obtained in production examples 2 and 3 and cleaning auxiliary particles CP1 to CP5 obtained in production example 4 were measured using a scanning electron microscope (JSM-7600F, manufactured by JEOL LTD.). In measuring the primary particle size, the circle-equivalent diameters (Heywood diameter: the diameter of a circle having the same area as the projected area of a primary particle) of one hundred primary particles were measured and their number average value was determined. Table 1 shows, along with the compositions of the resin fine particles, the average particle sizes of resin fine particles RA1 to RA5, RB1 to RB5, RC1, and RC2. Table 2 shows the average particle sizes of CP1 to CP5 along with the blending time T.

TABLE 1

| Resin Fine Particles | Particle Size [nm] | Composition |
|---|---|---|
| RA1 | 40 | Silicone Modified Acryl |
| RA2 | 49 | ↑ |
| RA3 | 32 | ↑ |
| RA4 | 52 | ↑ |
| RA5 | 28 | ↑ |
| RB1 | 94 | ↑ |
| RB2 | 118 | ↑ |
| RB3 | 82 | ↑ |
| RB4 | 122 | ↑ |
| RB5 | 79 | ↑ |
| RC1 | 42 | Styrene Acryl |
| RC2 | 90 | ↑ |

TABLE 2

| CL Auxiliary Particle | Blending Time T [h] | Particle Size [nm] |
|---|---|---|
| CP1 | 22 | 150 |
| CP2 | 14 | 102 |
| CP3 | 50 | 300 |
| CP4 | 12 | 308 |
| CP5 | 51 | 94 |

[Measurement of Ratio of Coverage of Surface of Toner with External Additive]

The surface of the toner particle was observed using a scanning electron microscope to measure the ratio of coverage with the external additive. Specifically, a reflection electron image (surface image) of the toner particle was taken using a scanning electron microscope (JSM-7600F, manufactured by JEOL LTD.) and the image was analyzed using image analysis software (WinROOF, developed by MITANI CORPORATION) to determine the ratio of coverage with the external additive. For any part of the surface of the toner base particle where a plurality of types of external additive particles lay on each other, the outer-most external additive particle (specifically, the external additive particle present at the highest position relative to the surface of the toner base particle) was judged to cover that part. For example, for a part of the surface of the toner base particle where the first and second resin fine particles lay on each other in this order, the outer-most, that is the second, resin fine particle was judged to cover that part. The ratio of coverage was measured in ten fields of view for one toner particle and the arithmetic average of the obtained ten measurement values was taken as the ratio of coverage of that toner particle.

### [Evaluation of Cleaning Properties and Charging Stability of Toner]

With each of the toners of Practical Examples 1 to 11 and Comparative Examples 1 to 13, cleaning properties and charging stability were evaluated by the methods described below.

### (Cleaning Properties)

The evaluation developer obtained in production example 8 was loaded in a development device in an evaluation machine (TASKalfa 7054ci, manufactured by KYOCERA Document Solutions Inc.). On the other hand, toner corresponding to the developer loaded in the development device was loaded in a toner container in the evaluation machine. In a normal-temperature normal-humidity environment (temperature: 20° C., humidity: 50% RH), an 80% solid image was printed continuously on 100,000 sheets of A4-sized plain paper. Then, a half-tone image was printed on the whole face of an A3-sized printing sheet. In the obtained half-tone image, whether an image defect in the form of stripes was present or absent was checked visually. In addition, after the printing of the half-tone image, whether the components of the toner had attached to the surface of a charger was checked visually. The evaluation criteria for cleaning properties were as follows:
GOOD: No image defect in the form of stripes observed in the half-tone image and no attachment of toner components observed on the surface of the charger.
POOR: An image defect in the form of stripes observed in the half-tone image and attachment of toner components observed on the surface of the charger.

### (Charging Stability)

Using the evaluation machine mentioned above, a test image with a printing rate of 5% was printed continuously on 500 sheets of printing paper. After the printing, a development device was taken out of the evaluation machine, developer was collected from the surface of a magnet roller, and the charge amount of the toner (initial charge amount X) was measured. Next, using the evaluation machine, a test image with a printing rate of 5% was printed continuously on 100,000 sheets of printing paper. After the printing, the charge amount of the toner (after-durability printing charge amount Y) was measured by a method similar to the one for the initial charge amount X. The value of (initial charge amount X—after-durability printing charge amount Y) was calculated to be taken as the charge amount difference. For the measurement of charge amount, a Q/M meter (MODEL 212HS manufactured by Trek, Inc.) was used and by suction through a sieve (wire mesh), only toner was sucked out of the developer on the magnet roller. The evaluation criteria for charging stability were as follows:
VERY GOOD: A charge amount difference of less than 4 μC/g.
GOOD: A charge amount difference of 4 μC/g or more but less than 8 μC/g.
POOR: A charge amount difference of 8 μC/g or more.

Table 3 shows the results of evaluation of cleaning properties and charging stability with each of the toners of Practical Examples 1 to 11 and Comparative Examples 1 to 13 along with the types and coverage ratios of first and second resin fine particles and the type of cleaning auxiliary particles used in the production of the toners.

TABLE 3

| | Toner Composition | | | | | | |
|---|---|---|---|---|---|---|---|
| | | | | | CL | Evaluation Results | |
| | 1st Resin | Coverage | 2nd Resin | Coverage | Auxiliary | Charging | Cleaning |
| | Fine Particle | Ratio [%] | Fine Particle | Ratio [%] | Particle | Stability | Properties |
| Practical | RA1 | 14 | RB1 | 8 | CP1 | VERY | GOOD |
| Example 1 | | | | | | GOOD | |
| Practical | RA2 | 12 | RB1 | 8 | CP1 | GOOD | GOOD |
| Example 2 | | | | | | | |
| Practical | RA3 | 15 | RB1 | 8 | CP1 | VERY | GOOD |
| Example 3 | | | | | | GOOD | |
| Practical | RA1 | 10 | RB1 | 8 | CP1 | GOOD | GOOD |
| Example 4 | | | | | | | |
| Practical | RA1 | 19 | RB1 | 8 | CP1 | GOOD | GOOD |
| Example 5 | | | | | | | |
| Practical | RA1 | 14 | RB2 | 9 | CP1 | VERY | GOOD |
| Example 6 | | | | | | GOOD | |
| Practical | RA1 | 14 | RB3 | 10 | CP1 | GOOD | GOOD |
| Example 7 | | | | | | | |
| Practical | RA1 | 14 | RB1 | 6 | CP1 | VERY | GOOD |
| Example 8 | | | | | | GOOD | |
| Practical | RA1 | 14 | RB1 | 12 | CP1 | GOOD | GOOD |
| Example 9 | | | | | | | |
| Practical | RA1 | 14 | RB1 | 8 | CP2 | GOOD | GOOD |
| Example 10 | | | | | | | |
| Practical | RA1 | 14 | RB1 | 8 | CP3 | GOOD | GOOD |
| Example 11 | | | | | | | |
| Comparative | RA4 | 13 | RB1 | 8 | CP1 | GOOD | POOR |
| Example 1 | | | | | | | |
| Comparative | RA5 | 15 | RB1 | 8 | CP1 | POOR | GOOD |
| Example 2 | | | | | | | |
| Comparative | RA1 | 21 | RB1 | 8 | CP1 | GOOD | POOR |
| Example 3 | | | | | | | |
| Comparative | RA1 | 9 | RB1 | 8 | CP1 | POOR | GOOD |
| Example 4 | | | | | | | |
| Comparative | RA1 | 14 | RB4 | 10 | CP1 | GOOD | POOR |
| Example 5 | | | | | | | |
| Comparative | RA1 | 14 | RB5 | 13 | CP1 | POOR | GOOD |
| Example 6 | | | | | | | |
| Comparative | RA1 | 14 | RB1 | 13 | CP1 | GOOD | POOR |
| Example 7 | | | | | | | |
| Comparative | RA1 | 14 | RB1 | 4 | CP1 | POOR | GOOD |
| Example 8 | | | | | | | |
| Comparative | RA1 | 14 | RB1 | 8 | CP4 | GOOD | POOR |
| Example 9 | | | | | | | |
| Comparative | RA1 | 14 | RB1 | 8 | CP5 | GOOD | POOR |
| Example 10 | | | | | | | |
| Comparative | RC1 | 10 | RB1 | 8 | CP1 | GOOD | POOR |
| Example 11 | | | | | | | |
| Comparative | RA1 | 14 | RC2 | 9 | CP1 | GOOD | POOR |
| Example 12 | | | | | | | |
| Comparative | RA1 | 10 | RB1 | 8 | — | GOOD | POOR |
| Example 13 | | | | | | | |

Table 3 clearly shows the following: Practical Examples 1 to 11, which used, as the first resin fine particle externally added to the surface of the toner base particle, RA1 to RA3 with an average particle size of 32 to 49 μm and, as the second resin fine particle, RB1 to RB3 with an average particle size of 82 to 118 μm along with, as the cleaning auxiliary particle, CP1 to CP3 with an average particle size of 102 to 300 μm all had a coverage ratio with the first resin fine particle of 10 to 15% and a coverage ratio with the second resin fine particle of 6 to 12%, offering good cleaning properties and charging stability.

In particular, Practical Examples 1, 3, 6, and 8, which had a coverage ratio with the first resin fine particle of 14 to 15% and a coverage ratio with the second resin fine particle of 8 to 9% all had a charge amount difference of less than 4 μC/g, which was very good.

In contrast, Comparative Example 1, which used, as the first resin fine particle, RA4 with an average particle size of 52 μm, was good in charging stability but poor in cleaning properties. In contrast, Comparative Example 2, which used, as the first resin fine particle, RA5 with an average particle size of 28 μm, was good in cleaning properties but poor in charging stability. This is considered to be because, with too large a particle size, the first resin fine particles come off in larger amounts from the toner base particle; the external additives then easily tend to slip through. On the other hand, it is considered that, with too small a particle size, the first resin fine particles serve less effectively as a spacer; more toner particles then tend to attach to each other after durability printing, leading to lower charging stability.

Comparative Example 3, which had a coverage ratio with the first resin fine particle (RA1) of 21%, was good in charging stability but poor in cleaning properties. In contrast, Comparative Example 4, which had a coverage ratio with the first resin fine particle (RA1) of 9%, was good in cleaning properties but poor in charging stability. This is considered to be because, with too high a coverage ratio with the first resin fine particle (too large an addition amount), the first resin fine particles come off in larger amounts from the toner base particle; the external additives then easily tend to slip through. On the other hand, it is considered that, with too low a coverage ratio with the first resin fine particle (too small an addition amount), the first resin fine particles serve less effectively as a spacer; more toner particles then tend to attach to each other after durability printing, leading to lower charging stability.

Comparative Example 5, which used, as the second resin fine particle, RB4 with an average particle size of 122 μm, was good in charging stability but poor in cleaning properties. In contrast, Comparative Example 6, which used, as the second resin fine particle, RB5 with an average particle size of 79 μm, was good in cleaning properties but poor in charging stability. This is considered to be because, with too large a particle size, the second resin fine particles come off in larger amounts from the toner base particle; the external additives then easily tend to slip through. On the other hand, it is considered that, with too small a particle size, the second resin fine particles serve less effectively as a spacer; more toner particles then tend to attach to each other after durability printing, leading to lower charging stability.

Comparative Example 7, which had a coverage ratio with the second resin fine particle (RB1) of 13%, was good in charging stability but poor in cleaning properties. In contrast, Comparative Example 8, which had a coverage ratio with the second resin fine particle (RB1) of 4%, was good in cleaning properties but poor in charging stability. This is considered to be because, with too high a coverage ratio with the second resin fine particle (too large an addition amount), the second resin fine particles come off in larger amounts from the toner base particle; the external additives then easily tend to slip through. On the other hand, with too low a coverage ratio with the second resin fine particle (too small an addition amount), the second resin fine particles serve less effectively as a spacer; more toner particles tend to attach to each other after durability printing, leading to lower charging stability.

Comparative Example 9, which used, as the cleaning auxiliary particle, CP4 with an average particle size of 308 μm, was good in charging stability but poor in cleaning properties. In contrast, Comparative Example 10, which used, as the cleaning auxiliary particle, CP5 with an average particle size of 94 μm, was good in charging stability but poor in cleaning properties. This is considered to be because, with too large a particle size of the cleaning auxiliary particle, many resin fine particles are conveyed to (enter) the edge part of the cleaning blade and with too small a particle size, the cleaning auxiliary particles less effectively scrape off the resin fine particles and suppress the formation of agglomerations; in either case, the external additives easily tend to slip through.

Comparative Example 11, which used, as the first resin fine particle, non-silicone modified acrylic resin fine particles (RC1), and Comparative Example 12, which used, as the second resin fine particle, non-silicone modified acrylic resin fine particle (RC2), were good in charging stability but poor in cleaning properties. This is considered to be because, with the first and second resin fine particles not silicone-modified, the resin fine particles themselves are poor in flowability, resulting in the resin fine particles forming agglomerations and being conveyed to the edge part of the cleaning blade; the external additives then easily tend to slip through.

Comparative Example 13, which contained no cleaning auxiliary particles, was good in charging stability but poor in cleaning properties. This is considered to be because, with no cleaning auxiliary particles, the formation of agglomerations by the resin fine particles was not effectively suppressed; the external additives then tend to slip through.

The results described above show that setting the particle size and the coverage ratio of the first and second resin fine particle formed of silicone modified acrylic resin and the particle size of the cleaning auxiliary particle within appropriate ranges improve the charging stability and cleaning properties of toner.

The present disclosure finds application in positively chargeable toner for use in an electrophotographic method. Based on the present disclosure, it is possible to provide positively chargeable toner with satisfactory charging stability combined with satisfactory cleaning properties against a photosensitive drum.

What is claimed is:

1. Positively chargeable toner composed of toner particles, the toner particles each comprising:
a toner base particle; and
an external additive attached to a surface of the toner base particle,
wherein
the external additive includes:
a first resin fine particle and a second resin fine particle formed of silicone modified acrylic resin and
a cleaning auxiliary particle composed of an inorganic fine particle,
the first resin fine particle has a number average primary particle size of 30 nm or more but 50 nm or less, and a ratio of coverage of a surface region of the toner base particle with the first resin fine particles is 10% or more but 20% or less,
the second resin fine particle has a number average primary particle size of 80 nm or more but 120 nm or less, and a ratio of coverage of the surface region of the toner base particle with the second resin fine particles is 10% or more but 20% or less, and
the cleaning auxiliary particle has a number average primary particle size of 100 nm or more but 300 nm or less.

2. The positively chargeable toner according to claim 1, wherein
a blended amount of the cleaning auxiliary particles is 0.5 parts by mass or more but 2.0 parts by mass or less relative to 100 parts by mass of the toner particle.

3. The positively chargeable toner according to claim 1, wherein
the cleaning auxiliary particle is a strontium titanate particle.

4. Two-component developer comprising:
the positively chargeable toner according to claim 1; and
carrier by friction with which the positively chargeable toner is positively chargeable,
wherein
the carrier is silicone-coated carrier having a surface thereof coated with silicone resin.
